(19) United States
(12) Patent Application Publication
(10) Pub. No.: US 2008/0139753 A1
(43) Pub. Date: Jun. 12, 2008

(54) Highly Reactive Uretdione Group-Containing Polyurethane Compositions Based on 1,4-Diisocyanato-Dicyclohexyl Methane

(75) Inventors: Emmanouil Spyrou, Schermbeck (DE); Andrea Henschke, Dulmen (DE); Nicole Fresmann, Haltern am See (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa GmbH, Duesseldorf (DE)

(21) Appl. No.: 11/722,740

(22) PCT Filed: Oct. 28, 2005
(86) PCT No.: PCT/EP2005/055630

§ 371 Date: Oct. 22, 2007

(30) Foreign Application Priority Data
Dec. 24, 2004 (DE) 102004062588.3

(51) Int. Cl. C08F 283/04; C08F 4/42; C08F 4/00

(52) U.S. Cl. 525/420; 502/164; 502/159; 502/152

(57) ABSTRACT

The invention relates to polyurethane compositions which contain uretdione groups and are based on 1,4-diisocyanatocyclohexylmethane, particularly for polyurethane powder coating and adhesive compositions which can be cured at a low temperature, to a process for producing them, and to their use.

The invention relates to polyurethane compositions which contain uretdione groups and are based on 1,4-diisocyanatocyclohexylmethane, particularly for polvurethane powder coating and adhesive compositions which can be cured at a low temperature, to a process for producing them, and to their use.

Externally or internally blocked polyisocyanates which are solid at room temperature are valuable crosslinkers for thermally crosslinkable polyurethane (PIT) powder coating and adhesive compositions.

For instance, DE-A 27 35 497 describes PU powder coatings having outstanding weathering stability and thermal stability. The crosslinkers whose preparation is described in DE-A 27 12 931 are composed of e-caprolactam-blocked isophorone diisocyanate containing isocyanurate groups. Also known are polyisocyanates containing urethane, biuret or urea groups, whose isocyanate groups are likewise blocked.

The drawback of these externally blocked systems lies in the elimination of the blocking agent during the thermal crosslinking reaction. Since the blocking agent may thus be emitted to the environment it is necessary on ecological and workplace safety grounds to take particular measures to clean the outgoing air and to recover the blocking agent. The crosslinkers, moreover, are of low reactivity. Curing temperatures above 170° C. are required.

DE-A 30 30 539 and DE-A 30 30 572 describe processes for preparing poly addition compounds which contain uretdione groups and whose terminal isocyanate groups are irreversibly blocked with monoalcohols or monoamines. Particular drawbacks are the chain- terminating constituents of the crosslinkers, which lead to low network densities in the PU powder coatings and hence to moderate solvent resistances.

Hydroxy 1-terminated polyadditicm compounds containing uretdione groups are subject matter of EP 0 669 353, Because of their functionality of two they exhibit improved resistance to solvents. Powder coating compositions based on these polyisocyanates containing uretdione groups share the feature that, during the curing reaction, they do not emit any volatile compounds. At not less than 180° C., however, the baking temperatures are at a high level.

The use of amidines as catalysts in PU powder coating compositions is described in EP 0 803 524. Although these catalysts do lead to a reduction in the curing temperature they exhibit considerable yellowing, which is generally unwanted in the coatings sector. The cause of this yellowing is presumed to be the reactive nitrogen atoms in the amidines. They are able to react with atmospheric oxygen to form N-oxides, which are responsible for the discoloration.

EP 0 803 524 also mentions other catalysts which have been used to date for this purpose, but without indicating any particular effect on the curing temperature. Such catalysts include the organometallic catalysts known from polyurethane chemistry, such as dibutyltin dilaurate (DBTL), or else tertiary amines, such as 1,4-diazabicyclo[2.2.2]octane (DABCO), for example.

WO 00/34355 claims catalysts based on metal acetylacetonates: zinc acetylacetonate, for example. Such catalysts are actually capable of lowering the curing temperature of polyurethane powder coating compositions containing uretdione groups, but their reaction products are principally allophanates (M. Gedan-Smolka, F. Lehmann, D. Lehmann “New catalysts for the low temperature curing of uretdione powder coatings” International Waterhorne, High solids and Powder Coatings Symposium, New Orleans, Feb. 21-23,2001). Allophanates are the reaction products of one mole of alcohol and two moles of isocyanate, whereas in conventional urethane chemistry one mole of alcohol reacts with one mole of isocyanate. As a result of the unwanted formation of allophanate, therefore, isocyanate groups valuable both technically and economically are destroyed.

It was an object of the present invention to find particularly flexible and also high-reactivity polyurethane compositions containing uretdione groups, these compositions being curable even at very low temperatures and being particularly suitable for producing plastics and also for producing flexible, high-gloss or matt, light-stable and weather-stable powder coatings and adhesives. Surprisingly it has been found that the combination of polyurethanes containing uretdione groups and based on diisocyanatodicyclohexylmethane (H₁₂MDI) with certain catalysts leads to highly reactive coatings which are also particularly flexible.

Conventional uretdione-containing coating and adhesive compositions can be cured only at 180° C. or above under normal conditions (DBTL catalysis). With the aid of the low-temperature-curing coating and adhesive compositions of the invention it is possible, with a curing temperature of 100 to 160° C., not only to save on energy and cure time but also to coat or bond many temperature-sensitive substrates which at 180° C. would give rise to unwanted yellowing, decomposition and/or embrittlement phenomena. Besides metal, glass, wood, leather, plastics, and MDF board, certain aluminum substrates are predestined for this application. In the case of the aluminum substrates, an excessively high temperature load sometimes leads to an unwanted change in the crystal structure.

The present invention provides high-reactivity polyurethane compositions containing uretdione groups and essentially comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight and
B) at least one catalyst from the group of catalysts
   1. of the formula [XR¹R²R³R⁴^{]+ [R}⁵COO]⁻, X being either N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms,
   2. of the formula [XR¹R²R³R⁴]³⁰ [R⁵]⁻, X being either N or P, where R¹ to R⁴ simultaneously or independently of one another are alkyl, and aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to include not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F,
   3. of the formula M (OR¹)ₙ(OR²)ₘ(OR³)ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
   it being possible for these catalysts from the groups 1 to 3, present individually or in mixtures, to be surrounded by an inert shell and hence encapsulated;
C) if desired, at least one hydroxyl-containing polymer having an OH number of between 20and 500 mg KOH/gram with a weight fraction, based on the total formulation, of from 1 to 95%;
D) if desired, at least one compound which is reactive toward acid groups and has a weight fraction, based on the total formulation, of from 0.1 to 10%;
E) if desired, at least one acid in monomeric or polymeric form, in a weight fraction, based on the total formulation, of from 0.1 to 10%;
F) if desired, auxiliaries and additives and/or further catalysts with a weight fraction, based on the total formulation, of from 0.01 to 55%;
G) if desired, solvents in amounts of from 1 to 75% by weight, based on the total formulation, where the fraction of the catalyst under B) is from 0.001 to 3% by weight of the total formulation.

The invention also provides for the use of the polyurethane compositions of the invention for producing flexible surface coatings on metal, plastic, glass, wood or leather substrates or other heat-resistant substrates.

The invention also provides for the use of the polyurethane compositions of the invention for producing adhesive bonds on metal, plastic, glass, wood or leather substrates or other heat-resistant substrates.

Likewise provided by the invention are metal-coating compositions, particularly for automobile bodies, motorbikes and cycles, architectural components and household appliances, wood-coating compositions, glass-coating compositions, leather-coating compositions, and plastics-coating compositions.

The curing agent A) is composed, preferably entirely, of H₁₂MDI as starting material for the isocyanate component. The invention further embraces curing agents A) whose isocyanate component is composed of H₁₂MDI and at least one further aliphatic, aromatic, cycloaliphatic and/or (cyclo)aliphatic isocyanate component. Isocyanates used with preference are isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TD1) and tetramethylxylylene diisocyanate (TMXDI), alone or in mixtures, especially HDL IPDI, in amounts of from 1 to 50% by weight, based on the total amount of all isocyanates.

The isocyanate component is dimerized to give polyisocyanates containing uretdione groups, and this is followed by reaction with hydroxyl-containing compounds to give the curing agent A). Polyisocyanates containing uretdione groups are well known and are described in, for example, U.S. Pat. No. 4,476,054, U.S. Pat. No. 4,912,210, U.S. Pat. No. 4,929,724, and EP 0 417 603. The dimerization of H₁₂MDI was described only recently in WO 04 005 363 and WO 04 005 364. A comprehensive overview of industrially relevant processes for dimerizing isocyanates to uretdiones is supplied by J. Prakt. Chem. 336 (1994) 185-200. Conversion of isocyanates to uretdiones takes place generally in the presence of soluble dimerization catalysts, such as dialkylaminopyridines, trialkylphosphines, phosphoric triamides or imidazoles, for example. The reaction, conducted optionally in solvents but preferably in their absence, is terminated by addition of catalyst poisons when a desired conversion has been reached. Excess monomeric isocyanate is separated off afterward by short-path evaporation. If the catalyst is sufficiently volatile, the reaction mixture can be freed from the catalyst at the same time as monomer is separated off. In that case there is no need to add catalyst poisons. A broad range of isocyanates is suitable in principle for the preparation of polyisocyanates containing uretdione groups.

The conversion of these polyisocyanates bearing uretdione groups, in accordance with the invention the H₁₂MDI containing uretdione groups, preferably as sole polyisocyanate, or H₁₂MDI in mixtures with other polyisocyanates containing uretdione groups, preferably HDI, IPDI, to curing agents A) containing uretdione groups involves the reaction of the free NCO groups with hydroxyl-containing monomers or polymers, such as polyesters, polythioethers, poly ethers, polycaprolactams, polyepoxides, polyesteramides, polyurethanes or low molecular mass di-, tri- and/or tetraalcohols as chain extenders and, if desired, monoamines and/or monoalcohols as chain terminators, and has already been frequently described (EP 0 669 353, EP 0 669 354, DE 30 30 572, EP 0 639 598 or EP 0 803 524). Preferred curing agents A) containing uretdione groups have a free NCO content of less than 5% by weight and a uretdione group content of from 1 to 18% by weight (calculated as C₂N₂O₂, molecular weight 84). Preference is given to polyesters and monomeric dialcohols. Besides the uretdione groups, the coatings and adhesives curing agents may also contain isocyanurate, biuret, allophanate, urethane and/or urea structures.

The invention also provides for the use of at least one catalyst from the group of catalysts
1. of the formula [XR¹R²R³R⁴]³⁰ [R⁵COO]⁻, with X being N or P, where R¹ to R⁴simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms,
2. of the formula [XR¹R²R³R⁴]⁺ [R⁵]⁻, with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F,
3. of the formula M (OR¹)ₙ(OR²)ₘ(OR³⁾ₒ(OR⁴)ₚ(OR⁵)_{q}(OR⁶)ᵣ, where M is a metal in any positive oxidation state and is identical to the sum n+m+o+p+q+r, m, o, p, q, and r are integers from 0 to 6 which the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
in solid polyurethane coating and adhesive compositions which comprise polyurethane compositions containing uretdione groups and based on H₁₂MDI.

The catalysts B) essential to the invention satisfy
1. the formula [XR¹R²R³R⁴]⁺ [R⁵COO]³¹ , with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl. aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, or
2. the formula [XR¹R²R³R⁴]⁺ [R⁵]with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, or

3. the formula M (OR¹)ₙ, (OR²)ₘ(OR³⁾ₒ(OR⁴)ₚ(OR⁵)_{q}(OR⁶)ᵣ, where M is a metal in any positive oxidation state and is identical to the sum n+m+o+p+q+r, m, o, p, q, and r are integers from 0 to 6 which the sum n+m+o+p+q+r=1 to 6, the radicals R⁵ to R⁶ simultaneously or independently of one another are hydrogen or alkyl, aryl, aralkyl. heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms.

Examples of such catalysts in section 1. above are tetramethylammonium formate, tetramethylammonium acetate, tetramethylammonium propionate, tetramethylammonium butyrate, tetramethylammonium benzoate, tetraethylarnmonium formate, tetraethylammonium acetate, tetraethylammonium propionate, tetraethylammonium butyrate, tetraethylammonium benzoate, tetrapropylammonium formate, tetrapropylammonium acetate, tetrapropylaamonium propionate, tetrapropylammonium butyrate, tetrapropylammonium benzoate, tetrabutylammonium formate, tetrabutylammonium acetate, tetrabutylammonium propionate, tetrahutylammonium butyrate, tetrabutylammonium benzoate, tetrabutylphosphonium acetate, tetrabutylphosphonium benzotriazolate, ethyltriphenylphosphonium acetate, tetraphenylphosphonium phenoxide and trihexyltetradecylphosphonium decanoate.

Examples of such catalysts in section 2. above are methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrabutylphosphonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammoniuni hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetrabutylphosphonium fluoride, tetraoctylammonium fluoride and benzyltrimethyl ammonium fluoride.

Examples of such catalysts in section 3. above are lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide, and barium phenoxide.

It will be appreciated that mixtures of such catalysts B) 1.-3. can also be used. The catalysts are present in an amount of from 0.001 to 5% by weight, preferably from 0.01 to 3% by weight, based on the total formulation. The catalysts may include water of crystallization, in which case such water is not taken into account when calculating the amount of catalyst used: that is, the amount of water is removed from the calculation. Particular preference is given to using tetraethylammonium benzoate and tetrabutylammonium hydroxide.

One version of the invention includes the polymeric attachment of such catalysts B) to the curing agent A) or to hydroxyl-containing polymers C) as well. For example, free alcohol, thio or amino groups of the ammonium salts can be reacted with acid, isocyanate or glycidyl groups of the curing agents A) or hydroxyl-containing polymers C) in order to integrate the catalysts B) into the polymeric system.

In the case of the hydroxyl-containing polymers C) it is preferred to use alternatively polyesters, polyethers, polyacrylates, polyurethanes, polyethers and/or polycarbonates having an OH number of from 20 to 500 (in mg KOH/gram). Particular preference is given to polyesters having an OH number of from 30 to 150 and an average molecular weight of from 500 to 6000 g/mol. Such binders have been described, for example, in EP 0 669 354 and EP 0 254 152. These polymers can be either amorphous or (partially) crystalline. It will be appreciated that mixtures of such polymers can also be used. The polymers C) can be used in amounts of from 1 to 95% by weight, based on the total formulation.

It should be borne in mind in this context that the activity of these catalysts decreases significantly in the presence of acids. The conventional reaction partners of the uretdione-containing coating or adhesive curing agents include hydroxyl-containing polyesters. Because of the way in which polyesters are prepared, they occasionally still include acid groups to a small extent. The amount of acid groups in the polyesters should be below 20 mg KOH/g, since otherwise the catalysts are too greatly inhibited. In the presence of such polyesters which carry acid groups it is appropriate either to use the catalysts mentioned in excess, relative to the acid groups, or else to add reactive compounds which are capable of scavenging acid groups. Both monofunctional and polyfunctional compounds can be used for this purpose. The possibly crosslinking effect of the polyfunctional compounds, although unwanted on account of its viscosity-increasing effect, is nevertheless not generally disruptive, owing to the low concentration.

Reactive acid-scavenging compounds D) are common knowledge in paint chemistry. For example, epoxy compounds, carbodiimides, hydroxyalkylamides or 2-oxazolines, but also inorganic salts such as hydroxides, hydrogencarbonates or carbonates, react with acid groups at elevated temperatures. Suitable examples include triglycidyl ether isocyanurate (TGIC), EPIKOTE® 828 (diglycidyl ether based on bisphenol A, Shell), Versatic acid glycidyl esters, ethylhexyl glycidyl ether, butyl glycidyl ether, Polypox R 16 (pentaerythrltol tetraglycidyl ether, UPPC AG), and other Polypox grades containing free epoxy groups, Vestagon EP HA 320, (hydroxyalkylamide, Degussa AG), but also phenylenebisoxazoline, 2-methyl-2-oxazoline, 2-hydroxyethyl-2-oxazoline, 2-hydroxypropyl-2-oxazoline, 5-hydroxypentyl-2-oxazoline, sodium carbonate, potassium carbonate, and calcium carbonate. It will be appreciated that mixtures of such substances are also suitable. These reactive compounds can be used in weight fractions of from 0.1 to 10%, preferably from 0.5 to 3%, based on the total formulation.

Acids specified under E) are all substances, solid or liquid, organic or inorganic, monomeric or polymeric, which possess the properties of a Brönsted acid or a Lewis acid. Examples that may be mentioned include the following: sulfuric acid, acetic acid, benzoic acid, malonic acid, and terephthalic acid, and also copolyesters or copolyamides having an acid number of at least 20. The acid component E) can be used in amounts, based on the total formulation, of from 0.1 to 10% by weight.

For preparing coatings or adhesives, it is possible to add the additives F) customary in coatings or adhesives technology, such as leveling agents, e.g., polysilicones or acrylates, light stabilizers, e.g., sterically hindered amines, or other auxiliaries, as described in EP 0 669 353, for example, in a total amount of from 0.05 to 5% by weight. Fillers and pigments, such as titanium dioxide, for example, can be added In an amount up to 50% by weight of the total composition. Optionally, additional catalysts such as are already known in polyurethane chemistry may be present. These are primarily organometallic catalysts, such as dibutyltin dilaurate, or else tertiary amines, such as 1,4-diazabicyclo[2.2.2]octane, for example, in amounts of from 0.001 to 1% by weight.

Suitable solvents under G) include all liquid substances which do not react with other ingredients; e.g, acetone, ethyl acetate, butyl acetate, xylene, Solvesso 100, Solvesso 150, methoxypropyl acetate, and Dibasic ester. They can be used in amounts of from 1 to 75% by weight, based on the total formulation.

All of the constituents for preparing the polyurethane composition of the invention can be homogenized in suitable apparatus, such as heatable stirred tanks, kneading apparatus, flow tubes or else extruders, for example, in which upper temperature limits of 120 to 130° C. ought not to be exceeded. After it has been thoroughly mixed, the composition is applied to the substrate by appropriate techniques, such as rolling or spraying. Application of ready-to-spray powders to suitable substrates can take place by the known methods, such as by electrostatic powder spraying or by fluid-bed sintering electrostatically or otherwise. Application is followed by heating of the coated workpieces for the purpose of curing for from 1 to 60 minutes at a temperature of from 60 to 220° C., preferably from 6 to 30 minutes at from 80 to 160° C.

The subject matter of the invention is illustrated below with reference to examples.

### EXAMPLES

| Ingredients | Product description, manufacturer |
|---|---|
| VESTANAT H₁₂MDI | 1,4-diisocyanatocyclohexylmethane, |
| | Degussa AG, Coatings & |
| | Colorants, NCO content: 31.9% |
| IPDI uretdione | isophorone diisocyanate uretdione, |
| | Degussa AG, Coatings & |
| | Colorants, free NCO content: |
| | 17.4%, latent NCO content |
| | (uretdione): 20.2% |
| TBAB | tetrabutylammonium benzoate, |
| | Aldrich |
| 1,2,4-triazole | Aldrich |
| Sodium methoxide | Aldrich |
| DYNACOLL 7360 | (partially) crystalline polyester, |
| | Degussa AG, Coatings & |
| | Colorants, OH number: 30 mg KOH/g, |
| RESIFLOW PV 88 | leveling agent, Worlee |

1) Preparation of 1,4-diisocyanatocyclohexylmethune containing uretdione groups (not inventive)
a) Preparation of the dimerization catalyst sodium 1,2,4-triazolate (WO 2004/005364, p. 15) 14.2 g of sodium methoxide were diluted in 200 ml of methanol and admixed in portions with 17.4 g of 1,2,4-triazole. After four hours of heating at reflux temperature, the solvent was distilled off on a rotary evaporator and the residue was admixed with methylene chloride. The precipitated product was freed from residues of solvent at room temperature in a vacuum drying cabinet. This gave 26.3 g of sodium 1,2,4-triazolate.

b) Dimerization of 1,4-diisocyanatocyclohexylmethane (WO 2004/005364, p. 19)

1000 g of Vcstanat H₁₂MDI were admixed with a solution of 2 g of sodium triazolate (1a) in 25 ml of dimethyl sulfoxide and the mixture was stirred at 30° C. for four hours. During that time the NCO content had dropped to 26,4% by weight. Following the addition of 4.6 g of dibutyl phosphate, the precipitate was filtered off and the filtrate was freed from excess diisocyanate using a thin-film evaporator at a temperature of 155° C. and a pressure of 0.08 mbar. This gave a viscid oil having a latent NCO group content of 14.5%.

c) Preparation of a curing agent containing uretdione groups and based on Vestanat H₁₂MDI In a reactor, 315 g of dodecane-1,12-diol and 0.5 g of dibutyltin dilaurate were dissolved in 11 of acetone. The solution was heated to 50° C. With vigorous stirring and under an inert gas atmosphere. 684 g of uretdione from example 1b) were added. The reaction was monitored by means of titnmetric NCO determination and was at an end after 6 hours. Thereafter the solvent was removed on a rotary evaporator and the product was cooled and comminuted. The product possesses a melting range of 112 to 114° C. and a latent NCO content of 9.8%,

d) Preparation of a comparative curing agent based on IPDI uretdione

In a reactor, 316 g of dodecane-1,12-diol and 0.5 g of dibutyltin dilaurate were dissolved in 11 of acetone. The solution was heated to 50° C. With vigorous stirring and under an inert gas atmosphere, 683 g of IPDI uretdione were added. The reaction was monitored by means of titrimetric NCO determination and was at an end after 6 hours. Thereafter the solvent was removed on a rotary evaporator and the product was cooled and comminuted. The product possesses a melting range of 101 to 103° C. and a latent NCO content of 13.9%.

2) Powder coating compositions (A and B inventive, C and I) not inventive) (Amounts in % by weight):

| | Powder coating | DYNACOLL | | RESIFLOW |
|---|---|---|---|---|
| Examples | curing agent 1c | 7360 | TBAB | PV88 |
| A | 98 of 1c | 0 | 1 | 1 |
| B | 88 of 1c | 10 | 1 | 1 |
| C | 99 of 1c | 0 | 0 | 1 |
| D | 98 of 1d | 0 | 1 | 1 |

General preparation instructions for the powder coatings:

The comminuted ingredients—powder coating curing agent, catalysts, and leveling agent—are intimately mixed in an edge runner mill and then homogenized in an extruder at 130° C. maximum. The extrudate is cooled, fractionated, and ground to a particle size <100 μm with a pinned-disk mill. Using an electrostatic powder spraying unit, the powder thus prepared is applied at 60 kV to degreased iron panels and baked in a forced-air oven at 150° C. for 30 minutes (film thickness: 70 to 80 μm).

3) Results (A and B inventive, C and I) not inventive):

| | MEK test | Erichsen cupping | Ball impact (direct/indirect) |
|---|---|---|---|
| Examples | [double rubs] | [mm] | [inch*lbs] |
| A | >100 | 9 | 50/40 |
| B | >100 | 10.5 | 80/70 |
| C | 4 | 0.5 | <10/<10 |
| D | >100 | 9.5 | 20/<10 |

Erichsen cupping to DIN 53 156
Ball impact to ASTM D 2794-93

As is clearly apparent from these results, the inventive composition A is both reactive and flexible (direct and indirect ball impact can be measured). If, in contrast, the catalyst is omitted (C), there is also a disappearance of the reactivity (see MEK test or Erichsen cupping). In the case of D) an alternative uretdione based on IPDI was used. The reactivity is at a similarly high level to that of the inventive A, whereas the flexibility (ball impact) is much lower.

The inventive composition B illustrates the fact that the flexibility can be increased significantly by adding crystalline resins.

1-35. (canceled)

36. A high-reactivity polyurethane composition containing uretdione groups and having a melting point of above 40° C., essentially comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R¹R²R³R⁴]⁺ [R⁵COOT]³¹ , X being N or P, where R¹ to R⁴simultaneously or Independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. [XR¹R²R³R⁴]⁻, [R⁵]⁻, X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ(OR²)ₘ(OR³)ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, being optionally surrounded by an inert shell and hence encapsulated;
the fraction of the catalyst under B) being from 0.001 to 5% by weight of the total formulation.

37. A polyurethane composition as claimed in claim 36, comprising
C) at least one hydroxyl-containing polymer having an OH number of between 10and 500 mg KOH/gram with a weight fraction, based on the total formulation, of from 1 to 95%; and/or
D) at least one compound which is reactive toward acid groups and has a weight fraction, based on the total formulation, of from 0.1 to 10%; and/or
E) at least one acid in monomeric or polymeric form, in a weight fraction, based on the total formulation, of from 0.1 to 10%; and/or
F) auxiliaries and additives and/or further catalysts with a weight fraction, based on the total formulation, of from 0.01 to 55%.

38. A polyurethane composition as claimed in claim 36, comprising solvents G) in amounts from 1 to 75% by weight.

39. A polyurethane composition as claimed in claim 36, further comprising uretdione-containing curing agents A) based on isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetrarnethylxylylene diisocyanate (TMXDI), alone or in mixtures.

40. A polyurethane composition as claimed in claim 39, further comprising uretdione-containing curing agents based on IPDI and/or HDI

41. A polyurethane composition as claimed in claim 36, comprising uretdione-containing curing agents A) based on hydroxyl-containing polyesters, polythioethers, polyethers, polycaprolactams, polyepoxides, polyesteramides, polyurethanes, low molecular weight di-, tri- and/or tetraalcohols, monoamines and/or inonoalcohols, alone or in mixtures.

42. A polyurethane composition as claimed in claim 41, comprising polyesters and/or monomeric dialcohols.

43. A polyurethane composition as claimed in claim 36, comprising as hydroxyl-containing polymers B) polyesters, polyethers, polyacrylates, polyurethanes and polycarbonates, alone or in mixtures.

44. A polyurethane composition as claimed in claim 43, comprising polyesters having an OH number of from 30 to 150 mg KOH/g and an average molecular weight of from 500 to 6000 g/mol.

45. A polyurethane composition as claimed in claim 36, comprising catalysts B1) selected from tetramethylammonium formate, tetramethylammonium acetate, tetramemylammonium propionate, tetramethylammonium butyrate, tetramethylammoniurn benzoate, tetraethylammonium formate, tetraethylammonium acetate, tetraethylammonium propionate, tetraethylammonium butyrate, tetraethylammonium benzoate. tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate, tetrabutylammonium benzoate, tetrabutylphosphonium acetate, tetrabutylphosphonium formate, ethyltriphenyl-phosphonium acetate, tetrabutylphosphonium benzotriazolate, tetraphenylphosphonium phenoxide and trihexyltetradecylphosphonium decanoate.

46. A polyurethane composition as claimed in claim 36, comprising catalysts B2) selected from methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylamrnonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylamrnonium fluoride, benzyltrimethylammonium fluoride, tetrabutylpho sphonium hydroxide and tetrabutylphosphonium fluoride.

47. A polyurethane composition as claimed in claim 36, comprising catalysts B3) selected from lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide, and barium phenoxide.

48. A polyurethane composition as claimed in claim 36, wherein the catalysts are surrounded by an inert shell and hence encapsulated.

49. A polyurethane composition as claimed in claim 36, wherein the catalysts are attached polymerically.

50. A polyurethane composition as claimed in claim 36, comprising as hydroxyl-containing polymers C) polyesters, polyethers, polyacrylates, polyurethanes, and/or polycarbonates having an OH number of from 10 to 500 (in mg KOH/gram).

51. A polyurethane composition as claimed in claim 50, comprising hydroxyl-containing polyesters having an OH number of from 15 to 150 and an average molecular weight of from 500 to 6000 g/mol.

52. A polyurethane composition as claimed in claim 51, comprising polyesters based on succinic acid, adipic acid, suberic acid, azelaic acid, sebacic acid, dodecanedioic acid, tetrahydrophthalic acid, hexahydrophthalic acid, hexahydroterephthalic acid, endomethylenetetrahydrophthalic acid, glutaric acid, and—where available—their anhydrides.

53. A polyurethane composition as claimed in claim 36, comprising polyesters based on ethylene glyol, propane-1,2-diol and -1,3-diol, 2,2-dimethyipropane-1,3-diol, butane-1,4-diol, pentane-1,5-diol, hexane-1,6-diol, 2-methylpentane-1,5-diol, 2,2,4-trimethylhexane-1,6-diol, 2,4,4-trimethylhexane-1,6-diol, heptane-1,7-diol, decane-1,10-diol, dodecane-1,12-diol, 9,10-octadecene-1,12-diol, octadecane-1,18-dioi, 2,4-dimethyl-2-propylheptane-1,3-diol, butene-1,4-diol, butyne-1,4-diol, diethylene glycol, triethylene glycol, tetraethylene glycol, trans- and cis-1,4-cyclohexanedimethanol, the triols glycerol, hexane-1,2,6-triol, 1,1,1-trirnefhylolpropane and 1,1,1-trimethylolethane, and the tetraol pentaerythritol.

54. A polyurethane composition as claimed in claim 36, comprising as component D) epoxy compounds, carbodiimides, hydroxyalkylamides, basic salts and/or 2-oxazolines.

55. A polyurethane composition as claimed in claim 36, comprising as acid E) sulfuric acid, acetic acid, benzoic acid, malonic acid, terephthalic acid, but also copolyesters or copolyamides having an acid number of at least 20.

56. A polyurethane composition as claimed in claim 36, comprising as auxiliaries and additives F) leveling agents, such as polysilicones or acrylates, for example, light stabilizers such as sterically hindered amines, for example, fillers, and pigments.

57. A process for producing a high-reactivity polyurethane composition containing uretdione groups and essentially comprising mixing
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R²R³R⁴]⁺ [R⁵COO]³¹ , with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. [XR¹R²R³R⁴]⁺ [R⁵]⁻, with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ(OR²)ₘ(OR³)ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, being optionally surrounded by an inert shell and hence encapsulated; and
C) optionally, at least one hydroxyl-containing polymer having an OH number of between 10 and 500 mg KOH/gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0.1 to 10%;
F) optionally, auxiliaries and additives and/or further catalysts with a weight fraction, based on the total formulation, of from 0.01 to 55%; and
G) optionally, solvents in amounts of from 1 to 75% by weight, based on the total formulation;
where the fraction of the catalyst under B) is from 0.001 to 5% by weight of the total formulation, by homogenizing at temperatures from 60 to 150° C.

58. A powder coating composition comprising compounds as set forth in claim 36.

59. An adhesive composition comprising compounds as set forth in claim 36.

60. A catalyst for accelerating the curing of a high-reactivity polyurethane composition containing uretdione groups and essentially comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R²R³R⁴]⁺ [R⁵COO]³¹ , with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. of the formula [XR¹R²R³R⁴]⁺ [R⁵]⁻, with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to include not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ, (OR²)ₘ(OR³)ₒ(OR⁴)ₚ(OR⁵)_{q}(OR⁶)ᵣ, where M is a metal m any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, being optionally surrounded by an inert shell and hence encapsulated; and
C) optionally, at least one hydroxyl-containing polymer having an OH number of between 10 and 500 mg KOH/gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0.1 to 10%;
F) optionally, auxiliaries and additives and/or further catalysts with a weight fraction, based on the total formulation, of from 0.01 to 55%; and
G) optionally, solvents in amounts of from 1 to 75% by weight, based on the total formulation;

61. A method of preparing a liquid or pulverulent polyurethane coating or adhesive composition for metal, plastic, wood, glass, leather or other heat-resistant substrates comprising mixing a polyurethane composition and at least one catalyst of the formula
1. [XR¹R¹R²R³R⁴]³⁰ [R⁵COO]⁻, with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R3 is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. of the formula [XR¹R¹R²R³R⁴]⁺ [R⁵]³¹ , with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ(OR²)ₘ(OR³)ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another arc hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, optionally being surrounded by an inert shell and hence encapsulated.

62. A method for preparing a liquid or pulverulent high-reactivity polyurethane coating or adhesive composition containing uretdione groups for metal, plastic, wood, glass, leather or other heat-resistant substrates essentially comprising mixing
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R¹R²R³R⁴]⁺ [R⁵COO]⁻, with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. [XR¹R¹R^{2R}³R⁴]⁺ [R⁵]⁻, with X being N or P, where R¹ to R⁴simultaneously or independently of one another are alkyl, aryl, aralkyl, heteroaryl or alkoxyalkyl radicals having 1 to 18 carbon, atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ(OR²)ₘ(OR³)ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, being optionally surrounded by an inert shell and hence encapsulated: and
C) optionally, at least one hydroxyl-containing polymer having an OH number of between 10 and 500 mg KOH/gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0.1 to 10%;
F) optionally, auxiliaries and additives and/or further catalysts with a weight fraction, based on the total formulation, of from 0.01 to 55%;
G) optionally, solvents in amounts of from 1 to 75% by weight, based on the total formulation;
where the fraction of the catalyst under B) is from 0.001 to 5% by weight of the total formulation.

63. A metal-coating composition essentially comprising a polyurethane composition comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R¹R²R³R⁴]⁺ [R⁵COO]⁻ with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18carbon atoms which is linear or branched and additionally may have one or more alcohol, amino, ester, keto, thio, acid, urethane, urea or allophanate groups, double bonds, triple bonds or halogen atoms, and/or
2. [XR¹R¹R²R³R⁴]⁺ [R⁵]⁻, with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ(OR²)ₘ(OR³)ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms, said catalysts from groups 1 to 3, present individually or in mixtures, being optionally surrounded by an inert shell and hence encapsulated; and
C) optionally, at least one hydroxyl-containing polymer having an OH number of between 10 and 500 mg KOH gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0.1 to 10%;
F) optionally, auxiliaries and additives and/or further catalysts with a weight fraction, based on the total formulation, of from 0.01 to 55%;
G) optionally, solvents in amounts of from 1 to 75% by weight, based on the total formulation;
where the fraction of the catalyst under B) is from 0.001 to 5% by weight of the total formulation.

64. A wood-coating composition essentially comprising a polyurethane coating composition comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight: and
B) at least one catalyst of the formula
1. [XR¹R¹R²R³R⁴]⁺ [R⁵COO]⁻ with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. [XR¹R¹R²R³R⁴]⁺ [R⁵]⁻, with X being N or P, where R¹ to R⁴simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ, (OR²)ₘ(OR³)ₒ(OR⁴)ₚ(OR⁵)_{q}(OR6)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, being optionally surrounded by an inert shell and hence encapsulated; and
C) optionally, at least one hydroxyl-containing polymer having an OH number of between 10 and 500 mg KOH/gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0.1 to 10%;
F) optionally, auxiliaries and additives and/or further catalysts with a weight fraction, based on the total formulation, of from 0.01 to 55%;
G) optionally, solvents in amounts of from 1 to 75% by weight, based on the total formulation;
where the fraction of the catalyst under B) is from 0.001 to 5%> by weight of the total formulation.

65. A leather-coating composition essentially comprising a polyurethane coating composition comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R¹R²R³R⁴]⁺ [R⁵COO]⁻, with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. [XR¹R¹R²R³R⁴]⁺ [R⁵]³¹ with X being N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either Oil or F, and/or
3. M (OR¹)ₙ, (OR2)ₘ(OR³⁾ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto. thio, acid, urethane, urea or allophanate groups, double bonds, triple bonds or halogen atoms,
said catalysts from groups 1 to 3, present individually or in mixtures, being surrounded by an inert shell and hence encapsulated; and
C) optionally, at least one hydroxyl-containing polymer having an OH number of between 10 and 500 mg KOH gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0,1 to 10%;
F) optionally, auxiliaries and additives and/or further catalysts with a weight fraction, based on the total formulation, of from 0.01 to 55%;
G) optionally, solvents in amounts of from 1 to 75% by weight, based on the total formulation;
where the fraction of the catalyst under B) is from 0.001 to 5% by weight of the total formulation.

66. A plastics-coating composition essentially comprising a polyurethane composition comprising
A) at least one curing agent which contains uretdione groups, comprising the reaction product of the uretdione of diisocyanatodicyclohexylmethane (H₁₂MDI) and hydroxyl-containing compounds, having a free NCO content of less than 5% by weight and a uretdione content of from 1 to 18% by weight; and
B) at least one catalyst of the formula
1. [XR¹R¹R²R³R⁴]⁺ [R⁵COO]⁻, with X being able to be N or P, where R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms, and/or
2. [XR¹R¹R²R³R⁴]⁺ [R⁵]⁻, with X being N or P, where R¹ to R⁴simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to be not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F, and/or
3. M (OR¹)ₙ(OR²)ₘ(OR³⁾ₒ(OR⁴)ₚ(OR⁵)_{q}(OR⁶)ᵣ, where M is a metal in any positive oxidation state which is identical to the sum n+m+o+p+q+r, m, o, p, q, and r are integers from 0 to 6 and the sum n+m+o+p+q+r= 1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
said catalysts from groups 1 to 3, present individually or in mixtures, being optionally surrounded by an inert shell and hence encapsulated; and
C) optionally, at least one hydroxyl-containing polymer having an OH number of between 10 and 500 mg KOH/gram with a weight fraction, based on the total formulation, of from 1 to 95%;
D) optionally, at least one compound which is reactive toward acid groups and has a weight fraction, based on the total formulation, of from 0.1 to 10%;
E) optionally, at least one acid in monomeric or polymeric form, in a weight fraction, based on the total formulation, of from 0.1 to 10%:
F) optionally, auxiliaries and additives and/or further catalysts with a weight fraction, based on the total formulation, of from 0.01 to 55%;
G) optionally, solvents in amounts of from 1 to 75% by weight, based on the total formulation,
where the fraction of the catalyst under B) is from 0.001 to 5% by weight of the total formulation.

67. A metal coating as set forth in claim 63 for automobile bodies, motorbikes and cycles, architectural components and household appliances.

68. A coating composition as claimed in claim 63, comprising at least one of components C) to G).
